(19) United States
(12) Patent Application Publication
(10) Pub. No.: US 2008/0068327 A1
(43) Pub. Date: Mar. 20, 2008

(54) BACKLIGHT MODULE, LIQUID CRYSTAL DISPLAY AND METHOD FOR CONTROLLING THE SAME

(75) Inventor: Huan-Wen Chien, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEYOND INNOVATION TECHNOLOGY CO., LTD., Taipei (TW)

(21) Appl. No.: 11/566,281

(22) Filed: Dec. 4, 2006

(30) Foreign Application Priority Data
Sep. 15, 2006 (TW) 95134255

(51) Int. Cl. G09G 3/36

(52) U.S. Cl. 345/102

(57) ABSTRACT

A backlight module includes a control unit, a transformer unit, a light source unit, and a detection unit. The control unit generates a control signal and a protection instruction signal based on a detection signal group. The protection instruction signal instructs a state of the backlight module. The transformer unit transforms an input power into an output power according to the control signal. The light source unit receives the output power to emit light. The detection unit detects a state of the light source for generating the detection signal group.

### BACKGROUND OF THE INVENTION

1. Field of the Invention

The invention relates to a backlight module, and more particularly to a backlight module having a notification function relating to a reason for failure.

2. Description of the Related Art

Liquid crystal displays (LCDs) have come to replace conventional cathode ray tube (CRT) displays because they are thin, light, and emit a low level of radiation.

CRT displays employ an electron gun to shoot electrons against fluorescent powder on a fluorescent screen such that light is generated for displaying images. Because LCD does not produce light, a backlight module employed as a light source capable of providing high and uniform brightness.

If a conventional backlight module fails for a reason, such as high voltage, leakage current, or damaged lamp, a power transformer is shut down by a controller of the backlight module. Thus, images can no longer be displayed if the light source of the backlight module fails. Other elements however, continue to function normally, resulting in unnecessary power consumption.

Additionally, all signals of the conventional backlight module are tested to obtain the reason for failure, such as high voltage, leakage current, or damage lamp thus, the conventional method is costly, time consuming, and requires human intervention.

### BRIEF SUMMARY OF THE INVENTION

Backlight modules are provided. An exemplary embodiment of a backlight module comprises a control unit, a transformer unit, a light source unit, and a detection unit. The control unit generates a control signal and a protection instruction signal based on a detection signal group. The protection instruction signal instructs a state of the backlight module. The transformer unit transforms an input power into an output power according to the control signal. The light source unit receives the output power to emit light. The detection unit detects a state of the light source for generating the detection signal group.

Liquid crystal displays are also provided. An exemplary embodiment of a liquid crystal display comprises a backlight module and a processing module. The backlight module comprises a control unit, a transformer unit, a light source unit, and a detection unit. The control unit generates a control signal and a protection instruction signal based on a detection signal group. The protection instruction signal instructs a state of the backlight module. The transformer unit transforms an input power into an output power according to the control signal. The light source unit receives the output power for generating light. The detection unit detects the state of the light source for generating the detection signal group. The processing module drives a load according to the protection instruction signal.

An exemplary embodiment of a control method is described in the following. A control signal and a protection instruction signal are generated based on a detection signal group. A transformer unit is utilized to transform an input power into an output power according to the control signal. The output power is transmitted to a light source unit for emitting light. A state of the transformer unit and a state of the light source unit are detected for generating the detection signal group.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a backlight module;

FIG. 2 is a schematic diagram of an exemplary embodiment of a control unit;

FIG. 3 is a schematic diagram of an exemplary embodiment of a protection element;

FIG. 4a is a schematic diagram of an exemplary embodiment of a power supply module, an image processor, and a liquid crystal panel of a liquid crystal device;

FIG. 4b is a schematic diagram of an exemplary embodiment of a processing module;

FIG. 4c is a schematic diagram of another exemplary embodiment of the processing module; and

FIG. 5 is a schematic flowchart of a control method according to the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

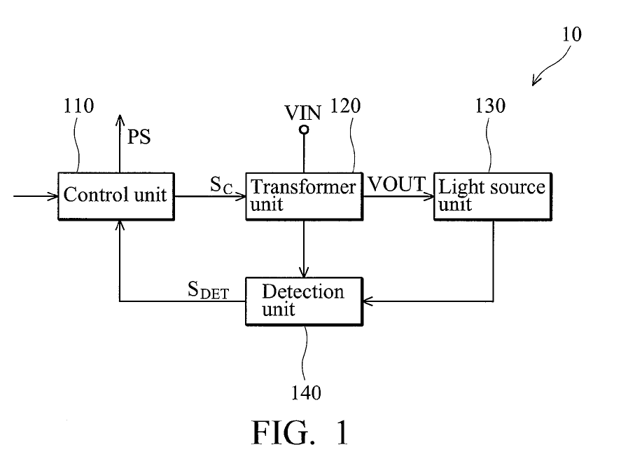

FIG. 1 is a schematic diagram of an exemplary embodiment of a backlight module. The backlight module 10 comprises a control unit 110, a transformer unit 120, a light source unit 130, and a detection unit 140.

The control unit 110 generates a control signal S_{C} and a protection instruction signal PS based on a detection signal group S_{DET}. The protection instruction signal PS instructs a state of the backlight module 10. The control unit 110 controls a state of the protection instruction signal PS based on detection signal group S_{DET}. The transformer unit 120 transforms an input power VIN into an output power VOUT according to the control signal S_{C}. The light source unit 130 receives the output power VOUT to emit light. The light source unit 130 could be a light emitting diode (LED) module or a lamp. The detection unit 140 detects a state of the light source unit 130 and/or a state of the transformer unit 120 for generating the detection signal group S_{DET}. In this embodiment, the detection unit 140 can detect a current state of the transformer unit 120, and a voltage state and a current state of the light source unit 130. Thus, the protection instruction signal PS comprises different states when the transformer unit 120 comprises different current states or the light source unit 130 comprises different voltage states or current states.

The detection unit 140 generates a current detection signal S_{DET-130} when detecting a current state of the light source unit 130. The detection unit 140 generates a voltage detection signal S_{DET-VOUT} when detecting a voltage state of the output voltage VOUT. The detection unit 140 generates a current detection signal S_{DET-120} when detecting the current state of the transformer unit 120. Thus, the control unit 110 generates the protection instruction signal PS based on one or a combination of the current detection signal S_{DET-130}, the voltage detection signal S_{DET-VOUT}, the current detection signal S_{DET-120}. In some embodiments, the control unit 110 refers to a protection reference table and provides a protection instruction signal PS corresponding to the detection signal group S_{DET} according to the reference result.

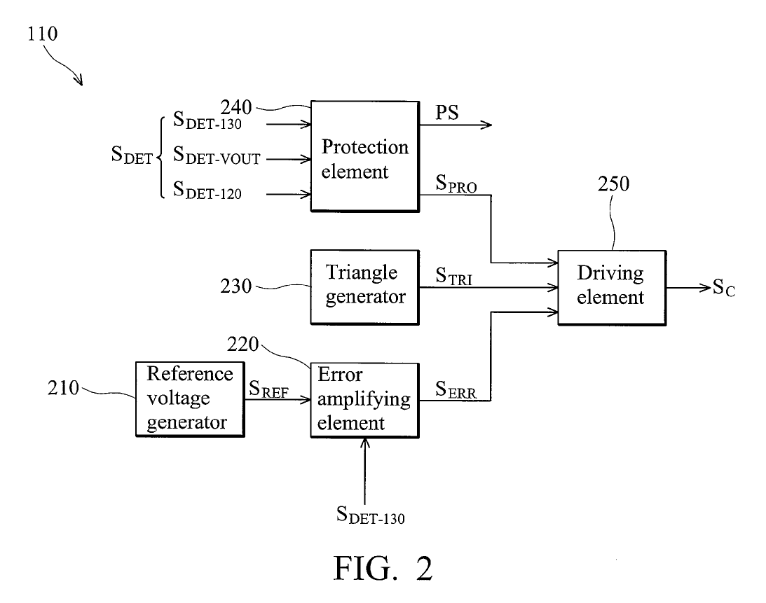

FIG. 2 is a schematic diagram of an exemplary embodiment of a control unit. The control unit 110 comprises a reference voltage generator 210, an error amplifying element 220, a triangle generator 230, a protection element 240, and a driving element 250.

The reference voltage generator 210 generates a reference voltage signal S_{REF}. The error amplifying element 220 generates an error signal S_{ERR} according to the current detection signal S_{DET-130} and the reference voltage signal S_{REF}. The triangle generator 230 generates a triangular signal S_{TRI}. The protection element 240 generates the protection instruction signal PS and a protection signal S_{PRO} according to the current detection signal S_{DET-130}, the voltage detection signal S_{DET-VOUT}, the current detection signal S_{DET-120}, or a combination of the current detection signal S_{DET-130}, the voltage detection signal S_{DET-VOUT}, and the current detection signal S_{DET-120}. The driving element 250 generates the control signal S_{C} according to the error signal S_{ERR} and the triangular signal S_{TRI} and further determines according to the protection signal S_{PRO} whether or not to output the control signal S_{C}. The protection instruction signal PS could be an analog signal similar to the protection signal S_{PRO} comprising ON and OFF states or an analog signal comprising a plurality of voltage levels. The reason for failure or the failed element is determined according to one or a combination of the current detection signal S_{DET-130}, the voltage detection signal S_{DET-VOUT}, and the current detection signal S_{DET-120}. For example, when the current detection signal S_{DET-120} is too high (i.e., an over current condition occurs in the transformer unit 120) and the voltage detection signal S_{DET-VOUT} is too low (an under voltage condition occurs in the output voltage), the transformer unit 120 is short circuited. If the voltage detection signal S_{DET-VOUT} is too high (an over voltage condition occurs in the output voltage) and the current detection signal S_{DET-130} is normal, the light source unit 130 is near the end of lifespan. Thus, an operator can rapidly determine the reason for failure and eliminate the failure according to the protection instruction signal PS.

In some embodiments, the protection element 240 refers to a protection reference table and provides the protection instruction signal PS corresponding to the detection signal group S_{DET} according to the reference result.

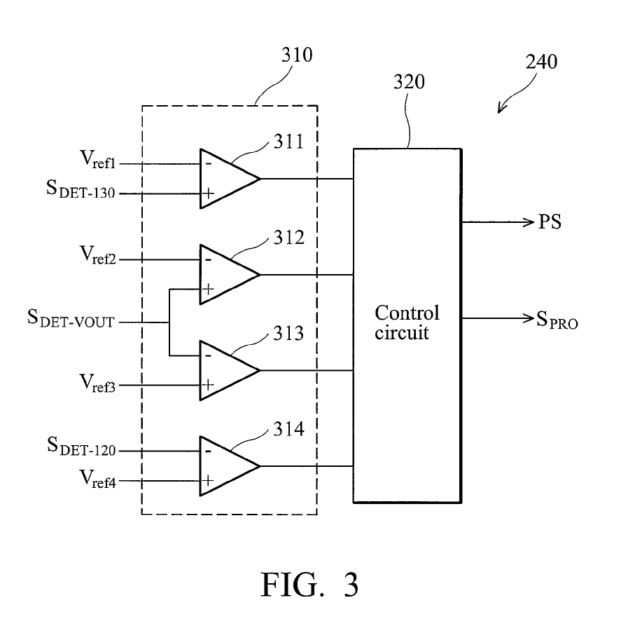

FIG. 3 is a schematic diagram of an exemplary embodiment of a protection element. The protection element comprises a comparison module 310 and a control circuit 320. The comparison module 310 compares the detection signal group S_{DET} with preset values V_{ref1}˜V_{ref4}. The control circuit 320 generates the protection instruction signal PS and the protection signal S_{PRO} according to the compared result.

In this embodiment, the comparison module 310 comprises comparators 311˜314. The comparator 311 compares the preset value V_{ref1} with the current detection signal S_{DET-130} When the current detection signal S_{DET-130} exceeds the preset value V_{ref1}, the over current condition occurs in the light source. The comparator 312 compares the preset value V_{ref2} with the voltage detection signal S_{DET-VOUT} and the comparator 313 compares the preset value V_{ref3} with the voltage detection signal S_{DET-VOUT} for determining whether the output voltage VOUT exceeds a preset range or not. When the voltage detection signal S_{DET-VOUT} exceeds the preset value V_{ref2}, an over voltage condition occurs in the output voltage VOUT. When the voltage detection signal S_{DET-VOUT} is less than the preset value V_{ref3}, an under voltage condition occurs in the output voltage VOUT. The comparator 314 compares the preset value V_{ref4} with the current detection signal S_{DET-120} for determining whether the current of the transformer unit 120 exceeds a preset value or not.

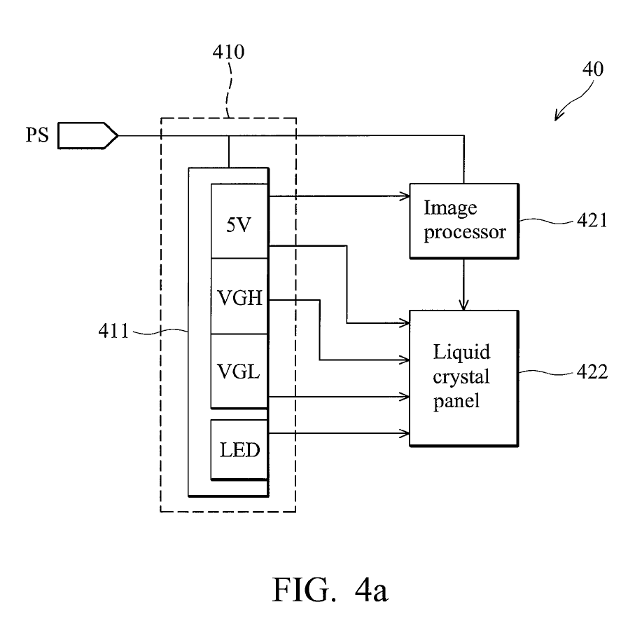

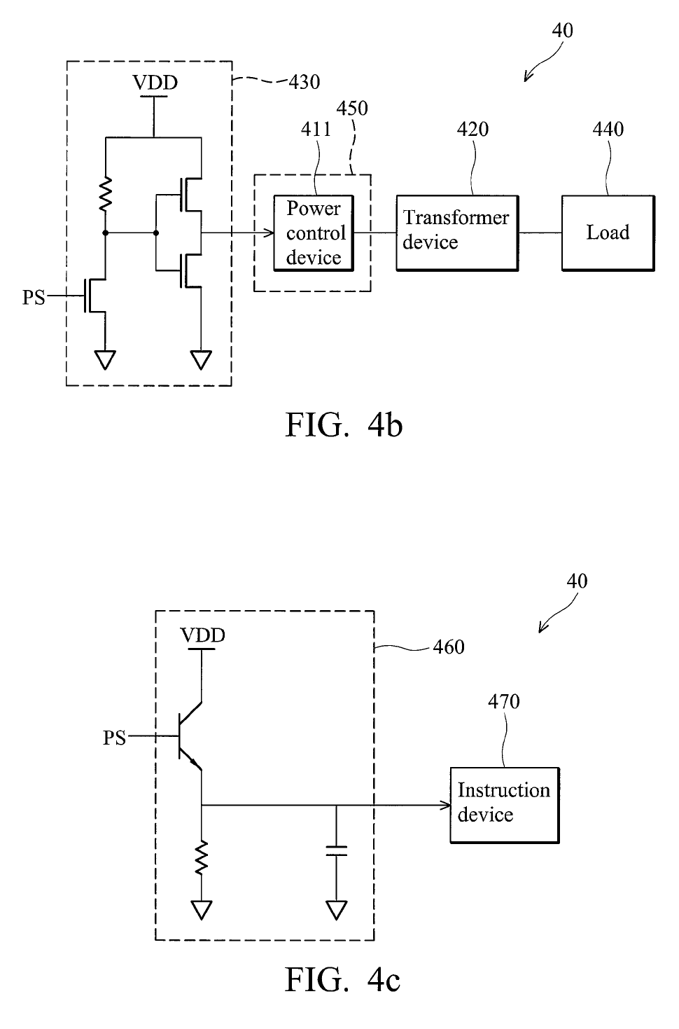

The protection instruction signal PS generated by the control unit 320 controls an operating state of a processing module. The processing module is an analog circuit or a digital circuit. FIG. 4a is a schematic diagram of an exemplary embodiment of a power supply module, an image processor, and a liquid crystal panel of a liquid crystal device. The power supply module 410, which is an analog circuit, and the image processor 421, which is a digital circuit, receive the protection instruction signal PS.

The power supply module 410 comprises a power control device (not shown) and a transformer device (not shown). The transformer device controlled by the power control device transforms an input power into an output power and provides the output power to a load. The power supply module 410 could be a 5V converting circuit, a gate high voltage converting circuit, or a gate low voltage converting circuit. The power control device is a controller of the 5V converting circuit, that of the gate high voltage converting circuit, or that of gate low voltage converting circuit. The power control device controls the corresponding converting circuit to provide the output power. If the protection instruction signal PS has no enough power to controls the power supply module 410, the protection instruction signal PS could control the power supply module 410 through utilizing a power amplifying device (not shown).

The image processor 421 provides a video signal to the liquid crystal panel 422 to display image data. The image processor 421 determines whether to provide the video signal to the liquid crystal panel 422 or insert corresponding video data into the image data according to the protection instruction signal PS. For example, when the backlight module has a failure and consequently can not emit light and the liquid crystal panel 422 still displays an image, a user can not see the image on the liquid crystal panel 422. Thus, operation of the image processor 421 can be halted. If the backlight module fails and can emit light (the current detection signal S_{DET-130} is not zero), the liquid crystal panel 422 displays an explanation text corresponding the reason for failure. Thus, the operator can quickly determine the reason for failure according to the explanation text. The liquid crystal panel 422 refers to a protection reference table and outputs the explanation text according to the reference result.

FIG. 4b is a schematic diagram of an exemplary embodiment of a processing module. The processing module 40 comprises a processing device 450, a transformer device 420, and a power amplifying device 430. The power amplifying device 430 amplifies the protection instruction signal PS. Because operation of the power amplifying device is well known to those skilled in the field, description thereof is omitted for brevity.

In this embodiment, the processing device 450 comprises a power control device 411. The power control device 411 controls the transformer device 420 such that the transformer device 420 transforms an input power into an output power and outputs the output power to a load 440.

FIG. 4c is a schematic diagram of another exemplary embodiment of the processing module. The processing module 40 comprises a power amplifying device 460. The power amplifying device 460 increases the driving ability of the protection instruction signal PS such that the instruction device 470 can be driven to provide a warning signal according to the protection instruction signal PS.

An instruction device 470 provides a warning signal according to the protection instruction signal PS such that the reason for failure can be obtained. In this embodiment, the instruction device 470 is a lighting device, such as a light emitting diode (LED), for providing light signal.

When the transformer unit 120 and the light source unit 130 shown in FIG. 1 are normal, the LED 470 is turned on and continuously emits light. When an over voltage condition occurs in the output voltage VOUT, the LED 470 emits light intermittently by a long period. When an under voltage condition occurs in the output voltage VOUT, the LED 470 emits light intermittently by a short period. When the light source unit 130 is damaged, the LED 470 is turned off and consequently does not emit light. When the transformer unit 120 is damaged (over current), the LED intermittently emits light by alternating between a long period and a short period.

Similarly, sounding is utilized to represent the reason for failure of the backlight module. In some embodiments, the instruction device 470 is a speaker module for generating sound. The duration of the sound is controlled by the protection instruction signal PS.

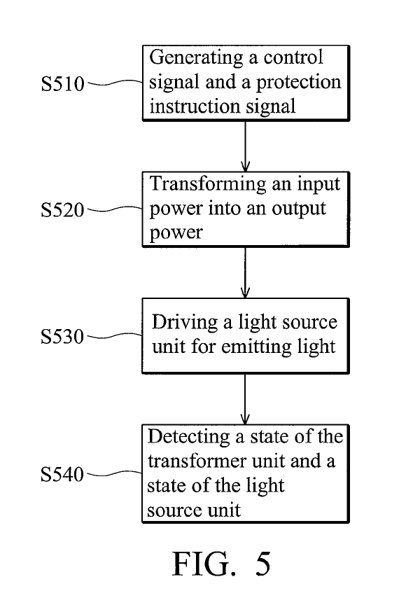

FIG. 5 is a schematic flowchart of a control method according to the present invention. The control method is applied in a backlight module. The schematic diagram of the backlight module is shown in FIG. 1.

First, a control signal S_{C} and a protection instruction signal PS are generated based on a detection signal group S_{DET} (step S510). The protection instruction signal PS instructs a state of the backlight module. In this embodiment, the control signal S_{C} is generated by a control unit 110. The control unit 110 could refer to a protection reference table and provides the protection instruction signal PS corresponding to the detection signal group S_{DET} according to the reference result.

Next, a transformer unit 120 is utilized to transform an input power VIN into an output power VOUT according to the control signal S_{C} (step S520).

The output power VOUT is transmitted to a light source unit 130 for emitting light (step S530). In this embodiment, the light source unit is a light emitting diode (LED) or a lamp.

A state of the transformer unit 120 and a state of the light source unit 130 are detected for generating the detection signal group S_{DET} (step S540). The state of protection instruction signal PS is changed according to the state of the transformer unit 120 and the state of the light source unit 130.

In this embodiment, the detection unit 140 generates a current detection signal S_{DET-130} according to a current of the light source unit 130, generates a voltage detection signal S_{DET-VOUT} according to a voltage of the output power VOUT, and generates a current detection signal S_{DET-120} according to a current of the transformer unit 120. Thus, the control unit 110 generates the protection instruction signal PS based on the current detection signal S_{DET-130}, the voltage detection signal S_{DET-VOUT}, the current detection signal S_{DET-120}, or the combination thereof.

In some embodiments, an operating state of a processing module is controlled according to the protection instruction signal PS, a speaker is driven by the protection instruction signal PS for sending an audio warning signal, or an LED module is driven by the protection instruction signal PS for an optical warning signal. Thus, the reason for failure is determined by the protection instruction signal PS.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a control unit generating a control signal and a protection instruction signal based on a detection signal group, wherein the protection instruction signal instructs a state of the backlight module;
a transformer unit transforming an input power into an output power according to the control signal;
a light source unit receiving the output power to emit light; and
a detection unit detecting a state of the light source for generating the detection signal group.

2. The backlight module as claimed in claim 1, wherein the control unit refers to a protection reference table and provides the protection instruction signal corresponding to the detection signal group according to the reference result.

3. The backlight module as claimed in claim 1, wherein the detection unit further detects a state of the transformer unit to generate the detection signal group.

4. The backlight module as claimed in claim 3, wherein the control unit refers to a protection reference table and provides the protection instruction signal corresponding to the detection signal group according to the reference result.

5. The backlight module as claimed in claim 3, wherein the detection signal group comprises a current detection signal of the light source unit, a voltage detection signal of the output power, or a current detection signal of the transformer unit.

6. The backlight module as claimed in claim 5, further comprising an instruction device providing a warning signal according to the protection instruction signal.

7. The backlight module as claimed in claim 6, wherein the instruction device comprises a light module or a speaker module.

8. The backlight module as claimed in claim 5, wherein the control unit comprises:
a reference voltage generator generating a reference voltage signal;
an error amplifying element generating an error signal according to the current detection signal of the light source unit and the reference voltage signal;
a triangle generator generating a triangular signal;
a protection element generating the protection instruction signal and a protection signal based on the current detection signal of the light source unit, the voltage detection signal of the output power, the current detection signal of the transformer unit, or a combination thereof; and
a driving element generating the control signal according to the error signal, the triangular signal, and the protection signal.

9. The backlight module as claimed in claim 8, further comprising a power amplifying device amplifying the protection instruction signal, and an instruction device providing a warning signal according to the protection instruction signal.

10. A liquid crystal display, comprising:
a backlight module comprising:
a control unit generating a control signal and a protection instruction signal based on a detection signal group, wherein the protection instruction signal instructs a state of the backlight module;
a transformer unit transforming an input power into an output power according to the control signal;
a light source unit receiving the output power to emit light; and
a detection unit detecting the a state of the light source for generating the detection signal group; and
a processing module driving a load according to the protection instruction signal.

11. The liquid crystal display as claimed in claim 10, wherein the detection unit further detects a state of the transformer unit to generate the detection signal group.

12. The liquid crystal display as claimed in claim 10, wherein the processing module is an image processor and the load is a liquid crystal panel driven by the image processor for displaying image data.

13. The liquid crystal display as claimed in claim 17, wherein the image processor refers to a protection reference table to provide the corresponding video according to the reference result and inserts corresponding video data into the image data according to the protection instruction signal.

14. The liquid crystal display as claimed in claim 10, wherein the processing module is a power control device and determines whether or not providing an output power to the load according to the protection instruction signal.

15. The liquid crystal display as claimed in claim 10, wherein the processing module comprises a power amplifying device and the power amplifying device drives the load according to the protection instruction signal such that the load provides a warning signal.

16. The liquid crystal display as claimed in claim 15, wherein the load is a light module or a speaker module.

17. The liquid crystal display as claimed in claim 10, wherein the control unit refers to a protection reference table and provides the protection instruction signal corresponding to the detection signal group according to the reference result.

18. The liquid crystal display as claimed in claim 17, wherein the control unit comprises:
a reference voltage generator generating a reference voltage signal;
an error amplifying element generating an error signal according to the current detection signal of the light source unit and the reference voltage signal;
a triangle generator generating a triangular signal,
a protection element generating the protection instruction signal and a protection signal based on the current detection signal of the light source unit, the voltage detection signal of the output power, the current detection signal of the transformer unit, or a combination thereof; and
a driving element generating the control signal according to the error signal, the triangular signal, and the protection signal.

19. The liquid crystal display as claimed in claim 18, further comprising a power amplifying device amplifying the protection instruction signal.

20. A control method, comprising:
generating a control signal and a protection instruction signal based on a detection signal group;
utilizing a transformer unit to transform an input power into an output power according to the control signal;
transmitting the output power to a light source unit for emitting light; and
detecting a state of the transformer unit and a state of the light source unit for generating the detection signal group.

21. The control method as claimed in claim 20, wherein the control unit refers to a protection reference table and provides the protection instruction signal corresponding to the detection signal group according to the reference result.

22. The control method as claimed in claim 20, further comprising controlling an operating state of a processing module according to a state of the protection instruction signal.

23. The control method as claimed in claim 20, further comprising generating a warning signal according to a state of the protection instruction signal.

24. The control method as claimed in claim 23, wherein the warning signal is an audio signal or an optical signal.
